(19) United States
(12) Patent Application Publication
(10) Pub. No.: US 2026/0217047 A1
(43) Pub. Date: Jul. 30, 2026

(54) APPARATUS AND METHOD FOR CONSTRUCTING A HARD BOOK COVER

(71) Applicant: GP2 Technologies, Inc., Bow, NH (US)

(72) Inventor: Thomas PORAT, Greenland, NH (US)

(73) Assignee: GP2 Technologies, Inc., Bow, NH (US)

(21) Appl. No.: 19/038,274

(22) Filed: Jan. 27, 2025

(51) Int. Cl. B42C 7/00; B42C 9/00

(52) U.S. Cl. CPC B42C 7/00; B42C 9/00

(57) ABSTRACT

An apparatus and method are provided for the fast, sequential production of different sized book cases (hard covers). The apparatus can self-adjust for different books without intervention from an operator. The entire case making process from uncut rigid boards and untrimmed print sheets to a final book case is achieved on a single apparatus, with as few as a single copy of each case made.

### FIELD OF THE INVENTION

This disclosure relates generally to an apparatus and method for making hard book covers, known in the art as “cases.” Specifically, the apparatus disclosed is specialized for sequentially producing individual book covers of different sizes.

### BACKGROUND

Hard book covers, or cases, are typically produced by attaching a print sheet to stiffening pieces of chipboard that provide rigidity. The print sheet includes the graphics and finish that will be seen by the reader once a book block is fixed to the case to produce a hard cover book. The rigid portion of the case, the board, is typically in at least two pieces, a front board and a back board and frequently a third piece, the spine. The board pieces are made from chipboard or other rigid material, typically cellulose. The board pieces are not only stiffer than the print sheet but are usually several times thicker. The board pieces are affixed to the print sheet, usually by gluing, and the print sheet is then folded around the edges of the board pieces to produce the case. Methods and apparatuses for making book cases are described in U.S. Pat. Nos. 10,099,489, 9,149,946, 8,123,449, 7,478,988 and 6,071,365, which are hereby incorporated by reference in their entireties herein.

### SUMMARY

In one aspect, a method of producing a hard cover case for a book is provided, the method comprising providing a print sheet including an image thereon, aligning the print sheet by registering two adjacent edges of the sheet at a plurality of stations, trimming only two adjacent edges of the print sheet, affixing the trimmed print sheet to a plurality of board pieces, and folding the print sheet around the board pieces to produce the hard cover case.

In another aspect an apparatus is provided, the apparatus including a print sheet feeder,
a board feeder, a print sheet edge cutter, a print sheet corner cutter, a board cutter, a gluing station, and a folding station. The apparatus can include an optical sensor for positioning a print sheet and a plurality of boards. The apparatus can sequentially make different size cases for books without operator input.

### BRIEF DESCRIPTION OF THE DRAWINGS

FIG. 1 is a top down view of one embodiment of an apparatus for making book cases;

FIG. 2 a board feeder and trimmer component of the apparatus of FIG. 1;

FIG. 3 illustrates a trimmed board being positioned on a staging table for additional trimming;

FIG. 4 illustrates a step after that shown in FIG. 3 in which the board has been advanced to a trimmer;

FIG. 5 shows a board slitter component of the apparatus of FIG. 1 with drives and supports removed for clarity;

FIG. 6A is an end profile view of the board slitter of FIG. 5;

FIG. 6B is a cutaway view illustrating the central portion of the board slitter of FIG. 5;

FIG. 6C is a cutaway view illustrating the carriage that supports the board slitter of FIG. 5;

FIG. 7 provides a top down view, with the upper portion removed, of an embodiment of a print sheet path through the case making process;

FIG. 8 is a cross-sectional side view illustrating an embodiment of a retention mechanism for enabling the transport and rotation of a print sheet;

FIGS. 9A-9D illustrate the transport of a print sheet through an edge cutting process;

FIGS. 10A-10C illustrate the transport of a print sheet through a corner cutting process;

FIGS. 11A and 11B illustrate the gluing and transfer of a print sheet;

FIG. 12 is a profile view of one embodiment of a case making apparatus with supporting structure removed to more clearly illustrate specific portions of the apparatus; and

FIG. 13 is a flow chart showing one embodiment of a process for making a case for a book.

The figures depict various embodiments of the present disclosure for purposes of illustration only. Numerous variations, configurations, and other embodiments will be apparent from the following detailed discussion.

### DETAILED DESCRIPTION

Many short run hard cover books are printed every year and include projects like photo albums and self-published books. Often these projects involve producing as few as one copy. Machines for making hard covers, commonly called casemakers, are typically designed for mass producing many copies of the same book size. With machines that are designed to produce fewer copies, there is still a need for making adjustments on the machine to accommodate book covers of different sizes and shapes. In many cases, specific guides on the machine may need to be adjusted. While machine adjustments have become more automated, no prior method or apparatus has been capable of sequentially producing cases with varying height, width, and spine width, in a fully automated mode without stopping or skipping cycles for machine adjustments. Furthermore, both print sheets and board parts need to be prepared or cut for making specific sized books. This is time consuming and logistically difficult for short run or small quantities. This means that producing single copies of 10 different book sizes takes longer to produce than does 10 copies of the same size book. The quality of the product can also suffer. For instance, the print sheet and the boards may be mismatched or misaligned, with the print sheet either too large or too small for the case, resulting in an imperfect book cover.

The apparatus described herein enables sequential automated production of different sized cases without pausing machine operation or skipping cycles. The apparatus is capable of cutting boards to size, trimming the print sheet to size, corner cutting and accurately affixing the print sheet to the boards to produce a case. From before the front, back and spine are separated, the apparatus can keep the individual pieces in registration with each other, so when they are glued to the print sheet they are within an acceptable tolerance (e.g., 1 mm) of their intended positioning. This can be accomplished with no intervention from an operator. While the apparatus is gluing one set of boards to a print sheet it can be concurrently trimming a different sized print sheet and cutting different sized board parts.

A case includes a print sheet, a front board, a back board and usually a spine board (spine). One side of the print sheet includes the book graphics and can be coated or uncoated stock. The print sheet is typically trimmed so when combined with the rigid board parts, the edges of the print sheet extend approximately 15 mm beyond the board edges and the print sheet corners are trimmed to reduce corner bulk in the finished case. These extended sheet edges are subsequently folded around the board edges.

The front board, back board and spine are positioned on the unprinted side of the print sheet. Typically there is a space, referred to as a hinge, between the front board and the spine as well as between the back board and the spine. The hinges provide flexibility that allows the finished book to be opened and closed. Glue can be coated onto the print sheet, the boards, or both, and the boards are fixed in place on the print sheet. The print sheet edges are then folded over the boards and pressed to make the finished case. The book is completed by gluing a book block (pages) into the case, typically by gluing a first and last page to the inside of the case. This is accomplished in a separate operation.

A print sheet may include one or more images printed on a standard size paper sheet. The print sheet can include one or more bar codes or other indicia that can be read by the apparatus. As used herein, bar code is meant to include any machine readable indicia printed on the sheet or boards that contains or points to information that is used by the apparatus to build the case. The bar codes can include instructions on trimming the print sheet as well as instructions on cutting the board parts to produce properly sized components, including front, rear and spine boards, for the particular book that is being produced. The bar code can include this information embedded therein or can point to an entry in a library that includes the information. After reading the information from the bar code, the apparatus can cut all of the components to size and also coordinates the combining of the board components with the print sheet in proper registration. After folding of the print sheet around the board components the print graphics must be properly aligned on the finished case.

It is important that board pieces are precisely aligned on the print sheet so that, after folding, the cover graphics are properly centered on the finished case. Each cut involved in trimming a print sheet introduces error that can lead to misalignment of graphics on the case. The apparatus described herein reduces that error by keeping two adjoining edges of the cover sheet untrimmed during the process. The two adjoining edges, at right angles to each other, are used as registration edges throughout the process and are referred to herein as the registration edges. The print sheet is trimmed to size by cutting material from the two edges opposing the registration edges. Note that portions of a registration edge will be cut when an adjoining edge is trimmed, but at least a portion, and typically most, of each registration edge remains uncut from when it was printed.

For the rigid components of the case, each of the front board, back board and spine board can be cut from a common sheet of board stock. It is important that each board be placed accurately on the print sheet and that the hinge on each side of the spine board is formed at the specified dimensions. The apparatus described herein assures alignment of these rigid components by trimming away board waste just prior to combining with the print sheet and never moving the components in relation to each other. Starting with a single piece of original board stock, the bar code on the associated print sheet defines the size of each of the three board pieces. These pieces are cut from the original board stock in the exact spatial relationship to each other as when they are combined with the glued print sheet. From the time that they are cut from the original board stock, the spatial relationship between these three pieces doesn't change. They are in the same relationship when glued to the print sheet as when they are cut from the single board.

Another issue that presents itself with the use of board pieces made of chipboard or other cellulosic materials is that the corners and edges of the original board stock can be easily damaged during storage, transportation and processing. The resulting edges and corners can result in an imperfect book cover or can result in jams during production. These imperfections can be difficult to screen for and can result in improper handling during the production process. The apparatus disclosed herein eliminates this problem by assuring that all four edges of the front board, the back board and the spine board are freshly cut after the board has been pulled from the board stack. All original corners of the original board are removed during production so that none of the finished pieces incorporate a corner that could have been damaged.

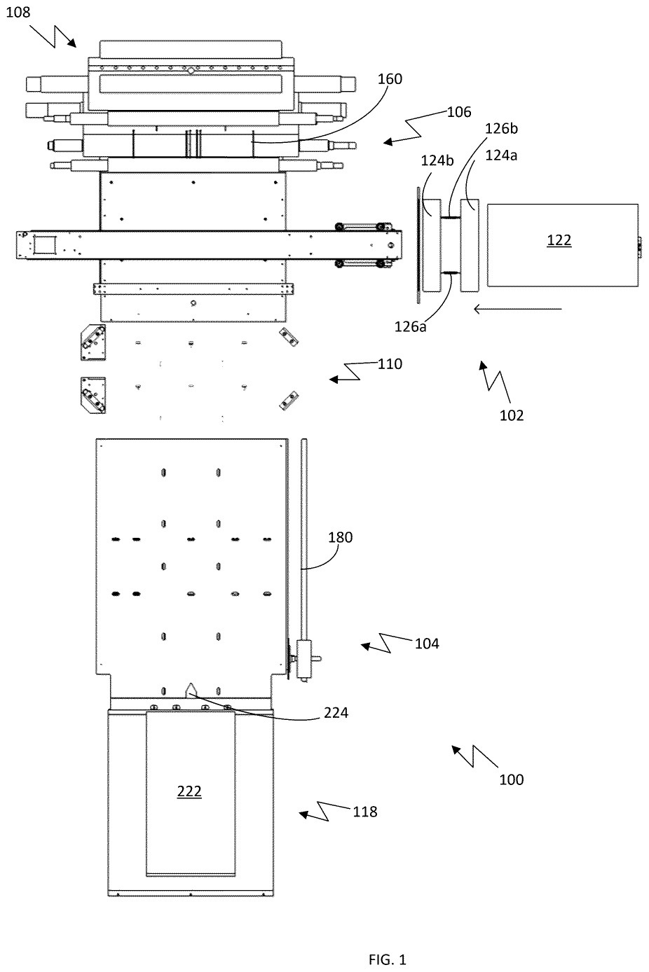

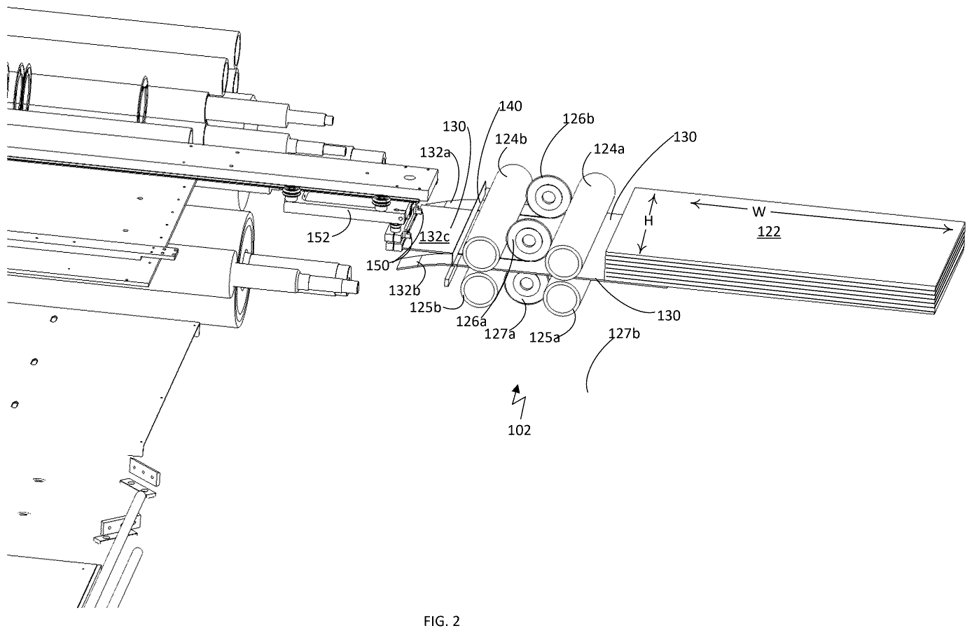

FIG. 1 provides an overhead view of one embodiment of the apparatus described herein. Case making machine 100 includes board feeder and trimmer 102, print sheet loader 118, print sheet bar code reader 224, print sheet edge cutting section 104, board slitter 106, gluing and press rolls 108 and print sheet corner cutters 110. Also shown are board stack 122, print sheet stack 222, board feed rollers 124a, 124b, 125a (FIGS. 2) and 125b (FIG. 2), and circular cutting knives 126a and 126b.

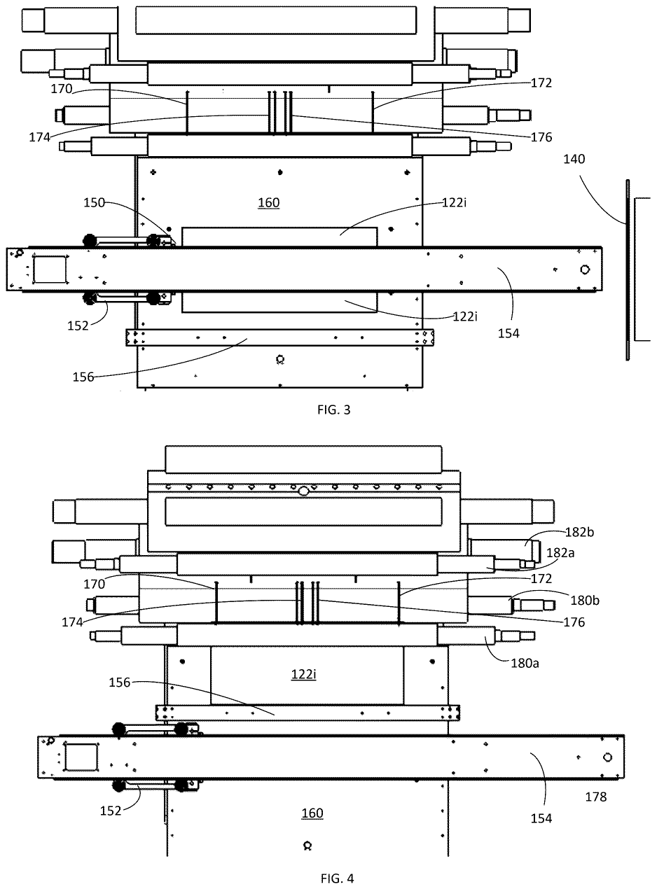

FIG. 2 provides a closer view of board feeder and trimmer 102. In this disclosure, the width of a board is that dimension shown by “W” in the figure. The height of a board is the dimension shown by “H” in the figure. The width corresponds to the width of the finished case made from the board. The height corresponds to the height of the case when a finished book is vertically shelved. As shown, a single original board 130 is drawn from the bottom of the stack. As used herein, an original board is a single board from which the front, rear and spine boards will be created. After the bar code on a print sheet (not shown) is read by the apparatus, the apparatus uses the information derived from the bar code to adjust circular knives 126a and 126b to be laterally spaced so that after the removal of waste pieces 132a and 132b the height of the board is equal to the height of the as yet unformed front, back and spine boards. Board 130 is advanced forward by feed rollers 124a, 124b, 125a and 125b until the amount of original board that hasn't passed by knife 140 is roughly equal to half an inch longer than the total width that is necessary to form the front, back and spine boards (including space for two hinges). When this point is reached, the knife is activated and cuts off waste piece 132c which falls into a waste bin. Waste pieces 132a and 132b may also be cut by guillotine knife 140 and drop into the waste bin, but regardless of whether or not the lateral knife cuts the edge waste pieces 132a and 132b, these pieces will fall into the waste bin as the cut board is advanced. After these cuts, the board is referred to as an intermediate board. The intermediate board includes three freshly cut edges and one original (trailing) edge. As the waste pieces fall away, the intermediate board is advanced to grippers 150 that grasp the intermediate board by the leading edge. Carriage 152 and grippers 150 move along support beam 154 (FIG. 3) and pull the intermediate board from feed rollers 124a, 124b, 125a and 125b so that these rollers are no longer in control of the board and are ready to receive the next original board.

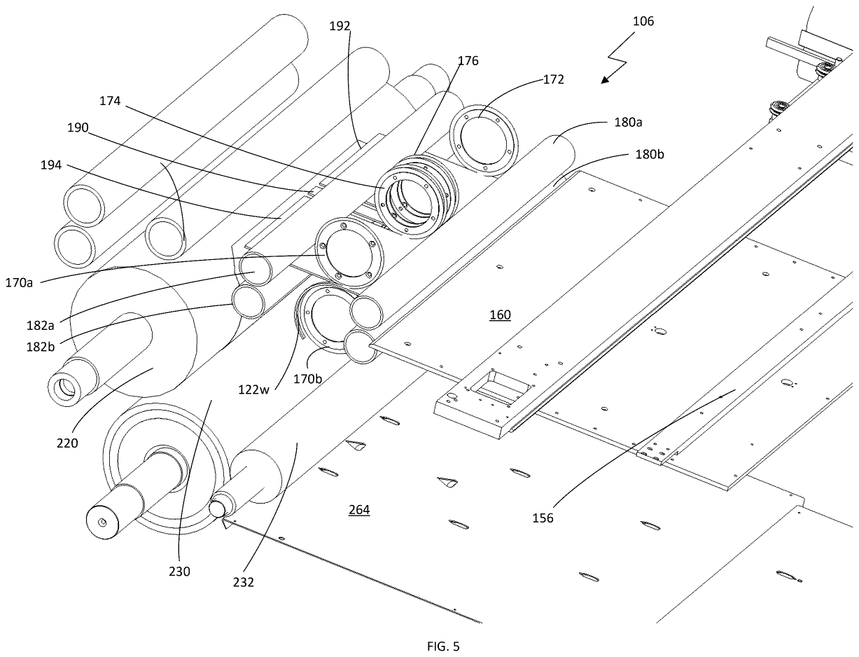

The intermediate board 122i is moved and released by grippers 150 onto staging table 160 as shown in FIG. 3. The intermediate board 122i is placed in position on the staging table 160 and is not retained by any guides or clamps at this point. Pusher bar 156 is used to advance the intermediate board to slitters 170, 172, 174 and 176. Each of these rotary slitters includes an upper knife and a lower knife. The lower knife portion 170b of knife 170 can be seen in FIG. 5. FIG. 4 shows a subsequent stage where pusher bar 156 has advanced intermediate board into press rolls 180a and 180b. These press rolls then subsequently feed the intermediate board 122i into the slitting knife sets 170, 172, 174, 176, and then press rolls 182a and 182b. Note that each of these knife sets includes an upper and lower circular knife, or pair of knives. Once the press rolls 180a and 180b have gripped the intermediate board 122i, the pusher bar 156 can retract to its previous position, ready to receive the next intermediate board, which may be the same or different size than the first one.

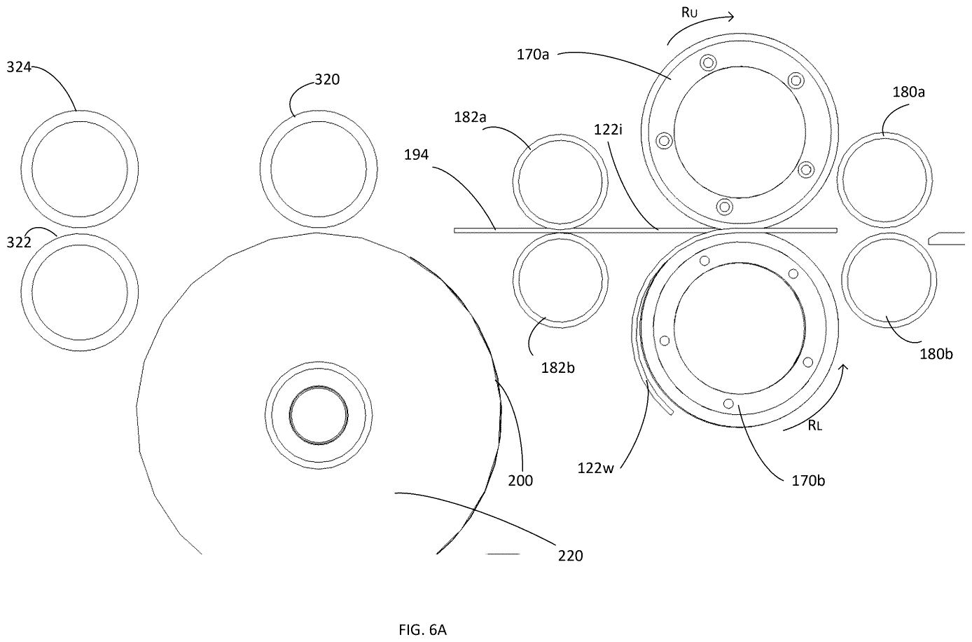

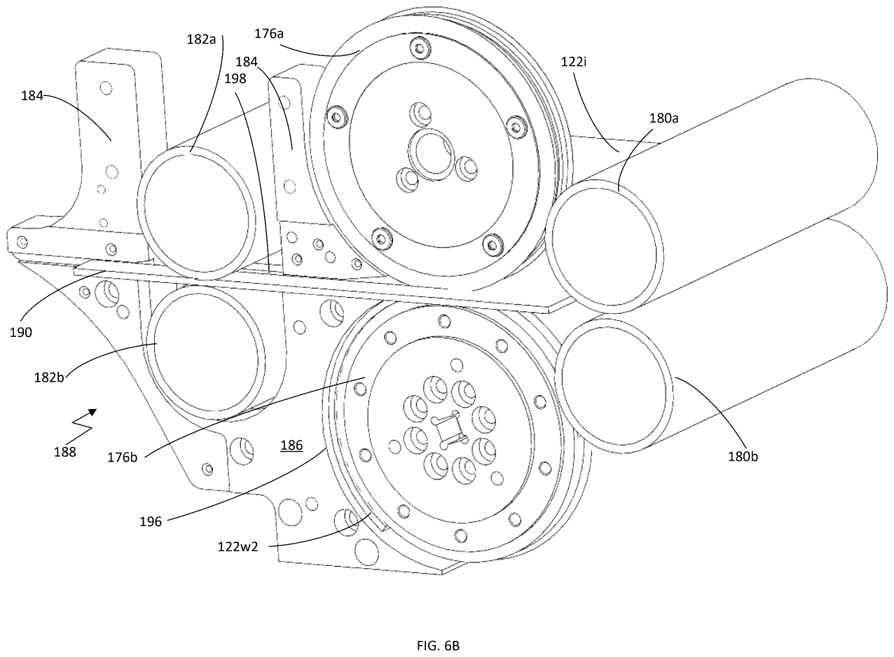

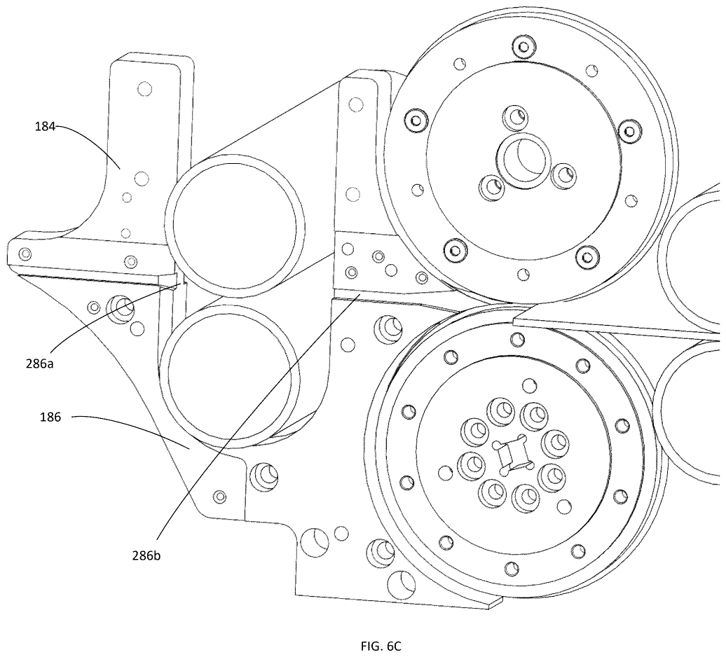

FIG. 5 provides a view of the slitting knives, with the mounting and drive portions removed for clarity. As shown, intermediate board 122i is being slit and fashioned into the final front, rear and spine boards. Note that the board is moving at a right angle to the direction it was transported in for the initial height cuts but is oriented in the same direction as when the initial cuts were made. As shown, both lateral edges of intermediate board 122i are being trimmed. As can be seen for knife 170a, a relatively small portion of the edge (<1 cm) is being removed. Waste piece 122w is sliced from the intermediate board and, as more easily seen in FIG. 6B, is carried downward and rearward with respect to the direction of the movement of the board. This directional waste disposal capability is important for keeping waste pieces from interfering with transfer roll 220 and with the remainder of the process that binds the board parts to the print sheet. The same feature is available for the opposed edge slitter 172. Note that by first cutting the intermediate board to an approximate width at board loader and trimmer 102, the width of waste board 122w is kept small (e.g., less than 1 inch or 1 cm) which can be critical for efficiently removing the waste board from the process. In some embodiments, trimming knives 170 and 172 would be unnecessary if the intermediate board width is accurately cut by knife 140 and then perfectly positioned prior to engaging press rolls 180a and 180b. In this case one board edge could remain untrimmed by the apparatus.

Centrally positioned knife sets 174 and 176 separate the front and back boards from the spine board. As shown, each of knife sets 174 and 176 are a pair of circular knives that work in tandem to carry away the hinge area waste material. Knives 170 and 172 can also each be pairs of knives. The space between each of the knives in pairs 174 and 176 is equal to the width of the hinge of the case. In some cases, this width can be adjusted but for most applications the hinge width can be consistent and the distance between the two knives of the knife pair can be fixed. However, each of the knife pairs sets can be adjusted laterally by the apparatus to accommodate different spine sizes. For example, for a half inch spine width, the inner facing knives of each of 174 and 176 will be spaced half an inch apart. If the next case being produced calls for a spine of ¾ inch, then the knives 174 and 176 can be laterally spaced apart to render a spine having a width of ¾ inch. The board section that is removed to provide the hinge is waste material and is disposed downwardly and rearwardly in a manner similar to waste board 122w. Note that these waste pieces are accumulated in a waste bin that is positioned between board staging table 160 and registration table 264. As can be seen in FIG. 5, spine board 190, front board 192 and back board 194 have been slit and the waste material removed. FIG. 6A provides a side profile view of the process at the same stage and shows the left edge cutter 170a and 170b. RL and RU provide the direction of rotation of the lower and upper knives respectively. FIG. 6B provides a cross-sectional view at the central portion of the slitting apparatus. Knife set 176 includes upper portion 176a and lower portion 176b. This knife set, which as shown is a pair of knives spaced ½ inch apart, is removing the waste material 122w2 which forms an empty space 198 that becomes the hinge of the case. A carriage 188 supports the bearings that support the knives. Upper carriage portion 184 supports the upper knife 176a and lower carriage portion 186 supports lower knife 176b. Lower carriage portion 186 supports upper carriage portion 184 via supports 286a and 286b (see FIG. 6C) that passes through the hinge area that was previously filled by waste 122w2. The upper and lower portions are physically connected via the hinge space. The board therefore could not advance if a hinge area were not being formed. Lower carriage portion 186 includes concave semicircular surface 196 that helps direct the waste board 122w2 downward and rearward once it has been removed from the board. Semicircular surface 196 is complementary to, and shares a similar curvature and radius to, circular knife 176(b). As the spine board 190, front board 192 and back board 194 are being slit, the pieces are captured and carried forward (right to left in FIG. 6) to contact glued print sheet 200 which is being carried by transfer roll 220. When the boards make contact with the print sheet, press rolls 182a and 182b are rotating at the same linear speed as is transfer roll 220. Note that the relative positioning of the spine, front, and back boards, in relation to each other, does not change from when the boards are formed and when joined to the print sheet. None of the boards need to be adjusted to make the case because they are cut in the exact same position, relative to each other, as they are joined to the print sheet. As described herein, the relative position of the spine board, front board, and back board has not changed from when the system loaded the original board 130.

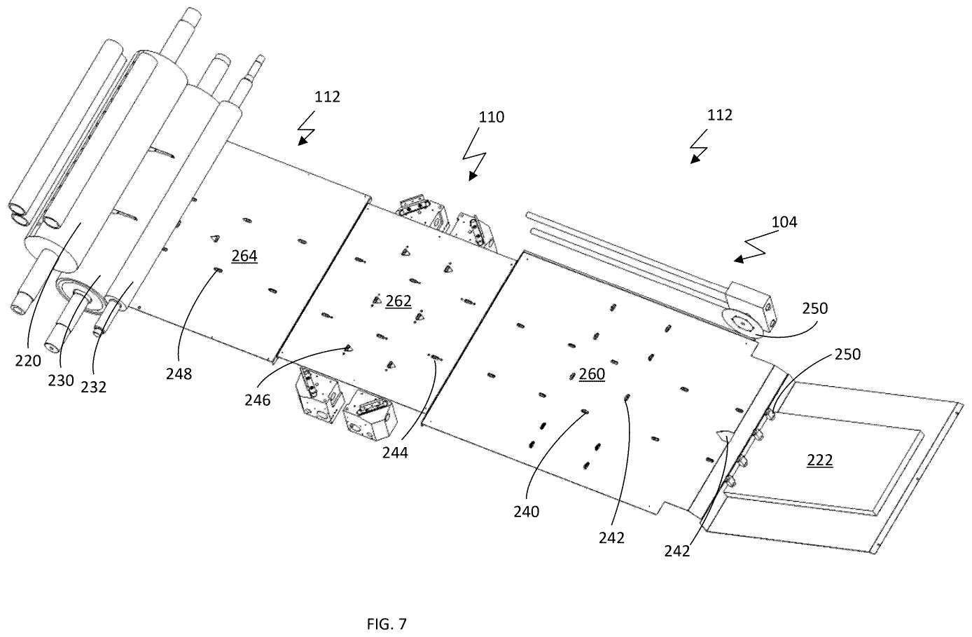

FIG. 7 provides an illustration of the print sheet processing train 112 with the board processing components removed for clarity. Print sheet stack 222 can include print sheets of different widths, different heights and different height to width ratios, but typically the original print sheet would come from one printer and be one common size. Different graphics and different coatings would be processed in the same way. In the embodiment shown, the sheets are stacked with the printed side down. Initial edge cutting area 260 is where the print sheets can be trimmed on a long side and a short side. Although all four sides can be trimmed, it is preferred to trim only two adjoining edges so that the opposed adjoining edges can be used for consistent corner justification throughout the case making process. A top sheet is pulled up off the stack by suction cups 250, scanned by a bar code reader 224 from below, and the leading edge is placed on staging table 260. Multiple wheels are accessible through openings in the staging table and are oriented either longitudinally or laterally with respect to the direction of movement of the print sheet through the case making process. For instance, drive wheel 240 is constructed and arranged to move the print sheet longitudinally and drive wheel 242 is designed to move a print sheet laterally. Together, the wheels can rotate a print sheet in place, around a stationary axis. Drive wheels can be independently controlled and can include a gripping but non-marring surface, or tire, that can be made of, for example, a polymer such as polyurethane. The top of a drive wheel can be positioned so that its upper edge is flush with the surface of the staging table 260, 262 or 264. The drive wheels described herein can be of varying diameter and, in some embodiments can be from 50 to 70 mm. They can be powered, for example, by independent servo or stepper motors.

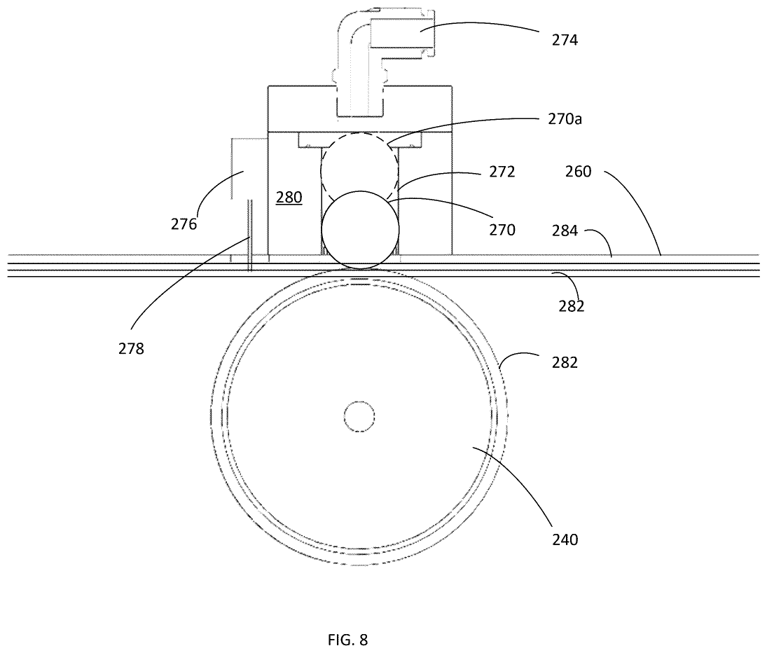

To properly grip and accurately control a cover sheet via a drive wheel there is a need to provide opposing pressure to engage the print sheet with the drive wheel. Furthermore, to accurately predict the movement of the sheet, the engagement between the transfer wheel and the print sheet must be secure, with no slippage, as the amount of travel of the sheet is a direct function of the amount of rotation of the drive wheels. The apparatus described herein uses a pneumatic system that controls the pressure on the drive wheels via a floating ball that presses downward against the drive wheel and the intervening print sheet. Other means of applying force to the ball such as electro-magnetism may be used. Other means to control the fiction between the sheet and drive wheel may be used, such as using a wheel in place of the mentioned ball. This pressure wheel could be positioned to press the sheet onto the drive wheel (or lift away when needed) and have a parallel axis with the drive wheel. One example of such a system is provided in FIG. 8. FIG. 8 includes lower plate 282 which supports the drive wheels and upper plate 284 which supports housing 280. The print sheet is sandwiched between the upper plate 284 and the lower plate 282. As shown, drive wheel 240 with gripping surface 282 is rotationally mounted below staging table 260. Above staging table 260, housing 280 secures cylinder 272 to fluid conduit 274. Vertically movable ball 270 can be moved between positions 270 and 270a by adding or removing air (or other gas) from cylinder 272. Tolerances between ball 270 and the inner diameter of cylinder 272 are selected to allow movement of the ball in the cylinder without an excessive loss of air through the system when it is either pressurizing to lower the ball or in vacuum mode to raise the ball. The lower end of the cylinder can include an interior rim that is of reduced diameter to prevent the ball from falling out. Air is provided or removed via fluid conduit 274 which is in communication with a valve, pump or other gas source that can alternately provide air pressure and vacuum. By controlling the pressure behind ball 270, the amount of force provided by the ball against the wheel (and the print sheet) can be less than, equal to, or greater than the weight of the ball. In the embodiment shown, ball 270 is hollow and made of aluminum. Preferably the ball is of a non-marring material and passively rotates in response to movement of the print sheet which is driven by drive wheel 240. As shown, the ball is of a ⅝-inch diameter and in other embodiments can be, for example, less than an inch in diameter or greater than ⅛ inch in diameter. When engaged, there can be about 5 or 10 psi pushing on the ball.

Also shown in FIG. 8 is print sheet position sensor 276. Print sheet position sensor 276 can be any sensor that can detect the edge of a print sheet without damaging the sheet. As shown, the sensor is one that does not need to physically contact the print sheet, such as an optical sensor that detects reflection of light off the print sheet. In some embodiments, a background suppression optical sensor is used. As shown, the optical sensor 276 is a retro reflective background suppression sensor. The sensor may see about 0.5 inches or less in the direction of the beam. Optical sensor 276 emits light beam 278 which can instantly detect the print sheet edge. Upper plate 284 and lower plate 282 include aligned openings that allow optical beam 278 to pass through. Using the methods described herein, two adjacent registration edges can be detected by the sensors, or detectors, and because registration edges have not been trimmed, the exact location of the graphics on the print sheet, as well as other edges of the print sheet, can be derived and used to accurately place the print sheet to establish proper registration to the boards.

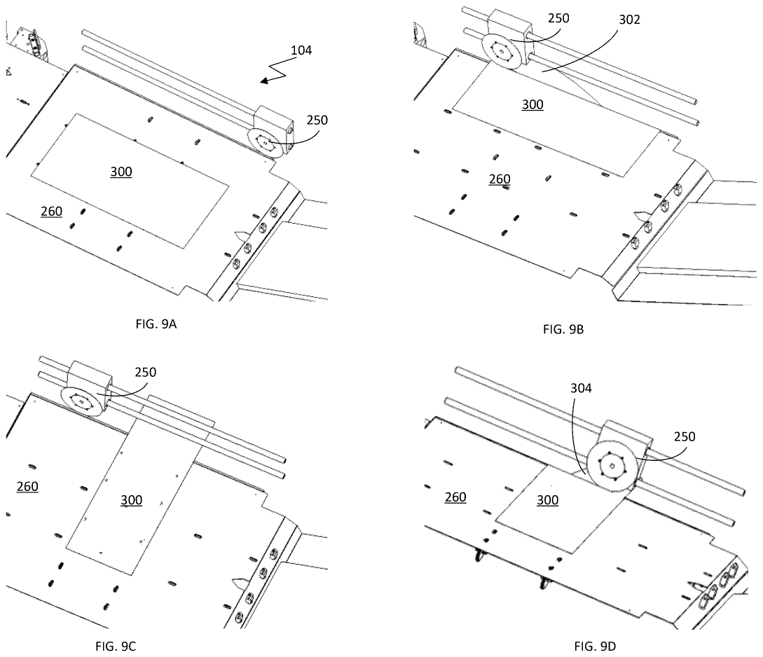

Referring back to FIG. 7, after vacuum cups 250 pick the first print sheet off of stack 222, the bar code on the print sheet is scanned and the information for the construction of the case is loaded into the system. The print sheet is advanced longitudinally by the longitudinally aligned wheel and ball pairs to the optical sensor (not shown in FIG. 7 as it is in the top portion that has been removed to show the staging table) that locates the edges of the sheet. See FIG. 9A. The apparatus is aware from the bar code information how much print sheet material needs to be trimmed from each trimming edge and can use the position of an untrimmed edge for reference. As shown in FIG. 9B, the print sheet is moved laterally toward edge cutting knife 250 and, once properly positioned, the knife is activated and trims off waste 302 which falls away. The remaining print sheet is then brought back to the middle of the staging table and rotated 90° by activating the four wheels at the center of the staging table, two longitudinal and two lateral wheels. The two longitudinal wheels rotate in opposite directions as do the two lateral wheels. In FIG. 9C the sheet is once again advanced laterally to cutting knife 250 and the short edge of the print sheet is trimmed to produce waste 304 as shown in FIG. 9D. Note that the cutting knife 250 cuts in both directions and does not need to be reset between cuts. Once the second edge has been trimmed, the print sheet is returned to the center of the staging table and is oriented to advance to the corner cutting station 110.

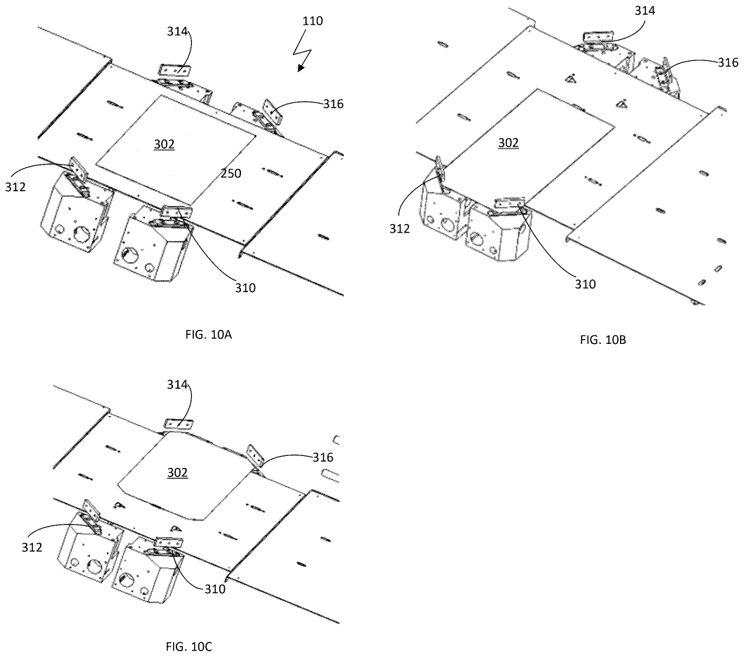

FIG. 10A shows the position of edge trimmed sheet 302 after transporting using the wheel and ball system from the edge cutting section 104 to the corner cutting section 110. Trimmed sheet 302 remains printed side down. In FIG. 10B, print sheet 302 has been transported left to the left pair of corner cutters, 310 and 312. Note that in the embodiment shown, the corner cutters do not move laterally in relation to the centerline of the system, but they do shift longitudinally. For example, knives 310 and 312 can be moved closer together or farther apart to accommodate different sized print sheets, or a bigger or smaller corner cut. In the embodiment shown, knives 312 and 314 move in tandem, as do 310 and 316. This is not necessary, but the corners are usually trimmed to the same extent on the right and left sides, so by moving in tandem the distance between 310/312 and 314/316 will be the same. In FIG. 10C the trimmed print sheet 302 is shifted laterally to the right side cutters and those corners are cut. The corner trimmed print sheet 306 is then returned to center and is ready to be transported to the registration section 264.

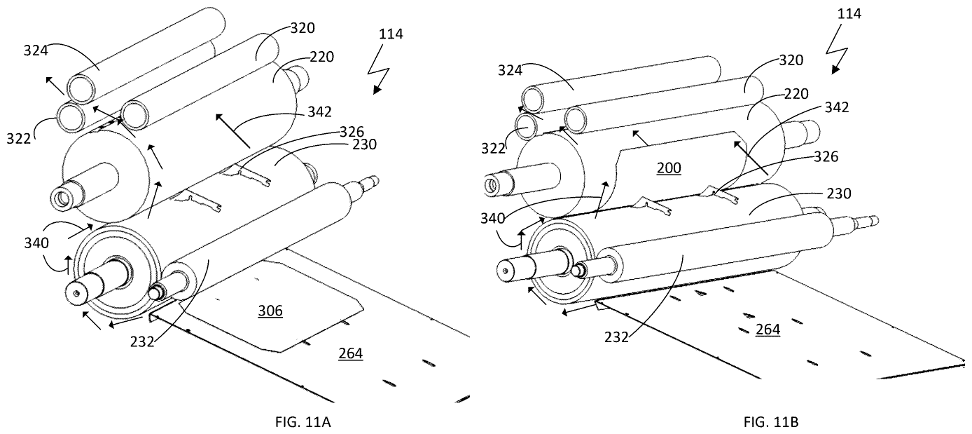

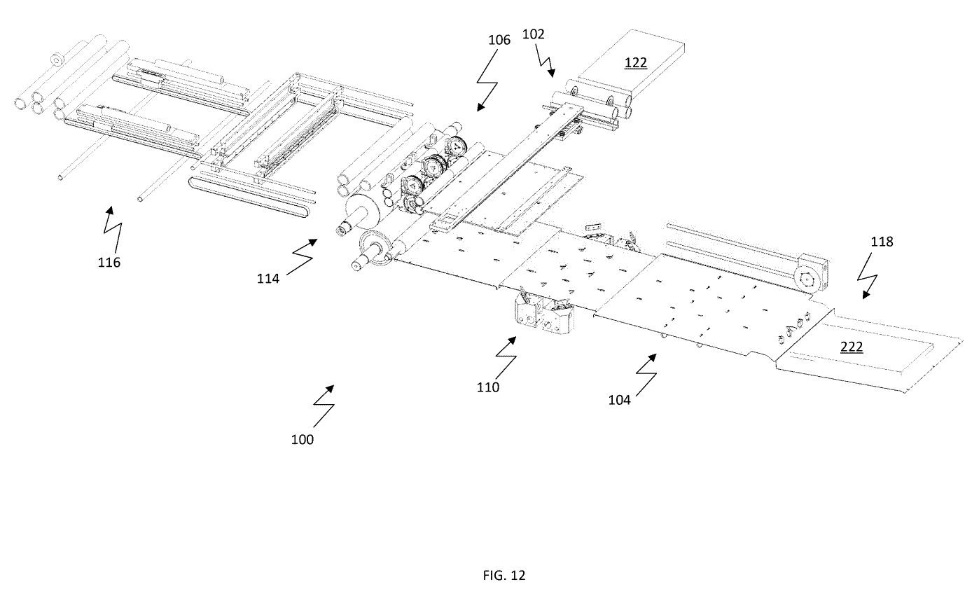

FIGS. 11A and 11B show gluing station 114 and the print sheet being transferred from the registration table 264, glued and combined with the front, rear and spine boards. In FIG. 11A, corner trimmed print sheet 306 is shown print side down and is manipulated by the drive wheels to be square and registered, via optical sensors, so that the apparatus knows where the leading edge and sides are located. The path indicated by arrows 340 is the path that the print sheet makes through the gluing station. Corner trimmed print sheet 306 is fed under glue distribution roll 232 and is transferred to glue roll 230 where the entire unprinted side of the print sheet is coated in glue. As the glue roll 230 continues in a clockwise direction, as shown, the corner trimmed print sheet travels about 180 degrees around the glue roll and is removed from the glue roll by picks 326. Picks 326 transfer the corner trimmed print sheet 306 to the transfer roll 220 as shown in FIG. 11B. Note that in FIG. 11B the glued, non-printed side of the sheet is facing the viewer and the printed side is against transfer roll 220, which in this case is a vacuum drum. Arrow 342 provides the general path of the front, rear and spine boards which are joined to the print sheet towards the top of transfer roll. (See FIG. 5) Press roll 320 combines the boards with the glued surface of glued print sheet 200, and the rigidity of the boards lifts the composite off of the transfer roll 220 and into press rolls 322 and 324 where the print sheet and boards are further compressed. From this point, the composite print sheet and boards are advanced to a folding station 116 (FIG. 12) where the corners are tucked and edges of the print sheet are folded around the board to form the case. The mechanics of the folding apparatus are similar to that disclosed in, for example, U.S. Pat. No. 6,071,365 which is incorporated herein.

### EXAMPLE

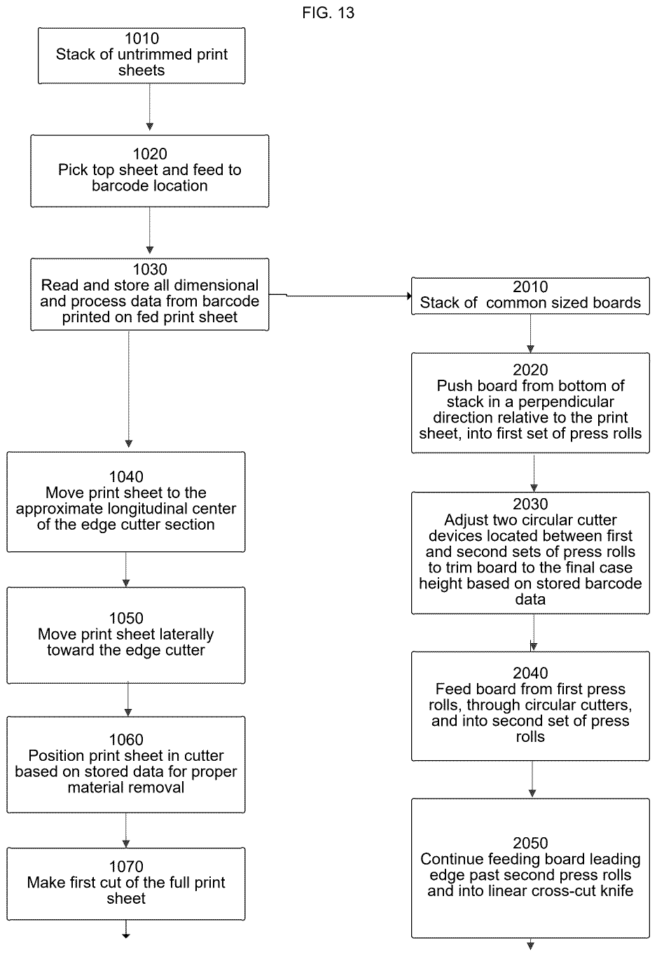

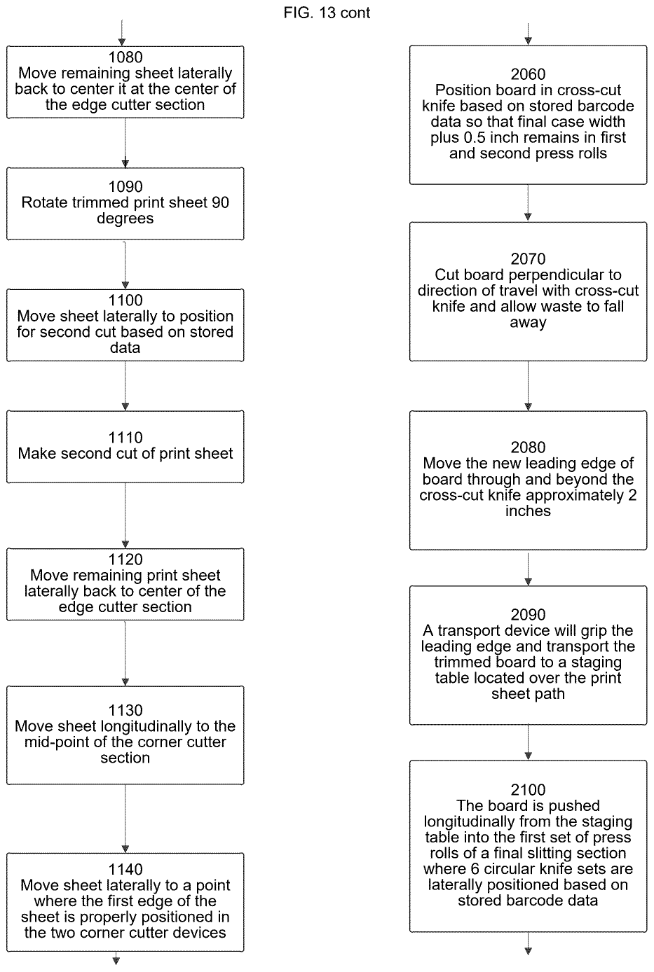

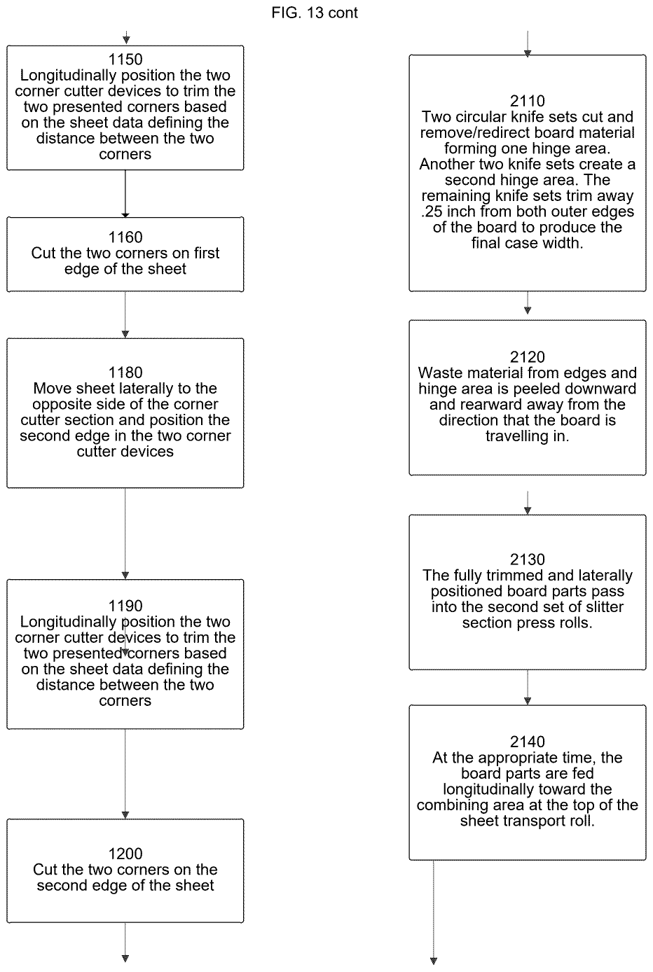

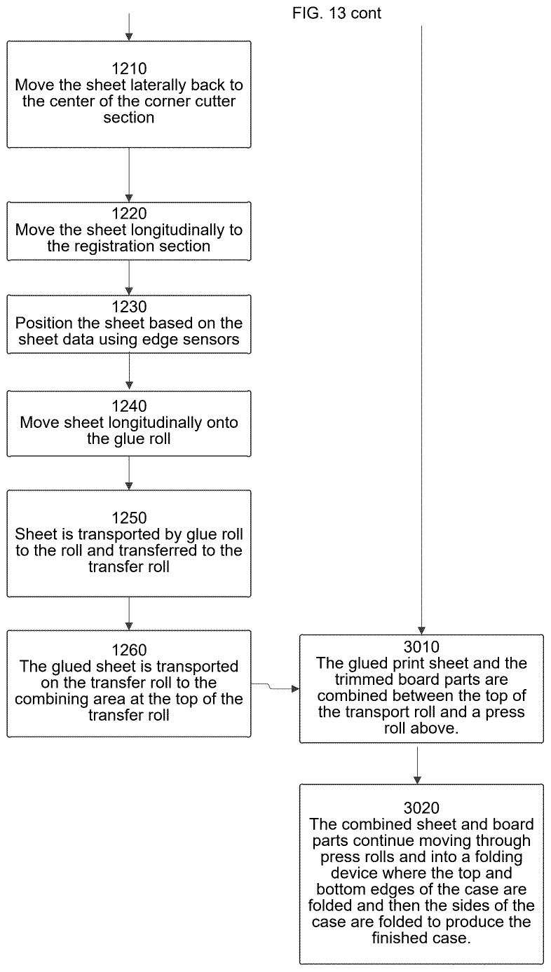

FIGS. 12 and 13 provide a flow of one embodiment of a process that can be carried out on the apparatus described herein. FIG. 12 provides a view of an apparatus that automatically produce cases of different sizes from a common sized original board and print sheets. The apparatus includes board feeder and trimmer 102, board slitter 106, print sheet feeder 118, print sheet edge cutter 104, print sheet corner cutter 110, gluing station 114 and folding station 116. Note that the print sheet travel is essentially linear from the print sheet stack 122 to the folding apparatus 116. The boards start in a first direction of travel and then make a 90 degree turn to be joined with the print sheet. When the board train and the print sheet train overlap, the board train is above the print sheet train. This results in a compact system that can be shipped in modules and assembled on a small footprint.

The process starts with steps 1010 and 2010 with a stack of original boards in a hopper and a stack of print sheets in a second hopper. In the embodiment shown, the physical size of the original boards are the same and the physical size of the starting print sheets is the same although the graphics of each sheet can be different and can vary in size. In step 1020 the top sheet of the print stack (printed side down) is pulled from the stack using a plurality of vacuum suction cups and is advanced to a scanner where 1030 the dimensional and process information is read from a barcode on the print sheet. The bar code can be printed during the standard print sheet printing process and can either be exposed or hidden when the case is finished, or it can be cut away in the trimming process. Continuing with the print sheet train 1000, the print sheet is moved to the longitudinal center of the edge cutter section 1040. This can be facilitated by drive wheels and optical sensors to sense the position of the sheet. The sheet is then moved laterally 1050 and the lateral edge is detected by optical sensors. The sheet is then advance laterally an additional amount set by the bar code information 1060 and the predetermined amount of the edge is removed 1070. The remaining portion of the print sheet then moves laterally back to the center of the edge cutting station 1080 and is rotated 90 degrees using drive wheels and opposing balls 1090. The print sheet then moves laterally again in the same direction as previously and, upon optical detection of the edge of the print sheet and using the data derived from the bar code, the sheet is advanced the proper distance, and the knife removes the predetermined amount of material 1110. The print sheet, now trimmed on two adjoining sides, is moved back to the center of the edge cutter section 1120. Using the drive wheels, the sheet is moved longitudinally to the center of the corner cutting section. The sheet is moved laterally to a point where one lateral edge of the sheet is positioned in the two corner cutter devices 1140. The longitudinal distance between the two lateral corner cutters is adjusted based on the bar code data 1150 and the corners are cut 1160. The print sheet is moved laterally to the opposite edge of the corner cutter device 1180 and the two remaining corners are cut based on the data derived from the bar code 1190 and 1200. The sheet is moved back to the center of the corner cutting section 1210 and then is moved longitudinally to the registration table 1220 where the sheet is positioned longitudinally and laterally and is squared up (theta) 1230 so that it can be moved onto the glue roll 1240 and then transferred to the transfer roll 1250 where it is rotated around to the combining area at the top of the transfer roll 1260.

The board production train starts with a stack of common sized boards 2010. A single board is extracted from the bottom of the stack in a direction that is perpendicular to the general direction of the movement of the print sheet. The board is pushed to a pair of press rolls 2020 and adjacent board edge cutters are adjusted, using print sheet bard code data 2030, to remove material from each of the top and bottom edges to render an intermediate board having its final height but not yet divided into sub-boards (front, rear and spine) 2040. The board is passed through the board edge cutters into a downstream set of second press rolls and across a guillotine type cross cut knife 2050. The board is positioned so that the cross cut knife is aligned at a position (from bar code information) that will cut off waste to leave a board secured by the press rolls that is equal to the final width of the case plus 0.5 inch 2060. The board is then cut by the cross cut knife and waste is allowed to fall out of the way of the path of the board 2070. The intermediate board, that has had three of four edges trimmed, is advanced past the cross cut knife and is grabbed by a transport device that grabs the newly trimmed leading edge and advanced the board to a staging table that is located above the print sheet path 2090. The gripper releases the intermediate board and drops it at roughly the center of the staging table. Using a push bar, the intermediate board is advanced (perpendicularly to its former direction of travel) to a new position determined by the bar code data and aligned with six circular knife sets 2100. One pair of knives removes the material to form one hinge and another pair of knives removes material to form the other hinge, another pair of knives removes 0.25 inch from one outer edge and another pair of knives removes 0.25 inch from the opposed outer edge 2110. Waste material is all less than 3/4 inch in width and is directed downward and away from the direction of board travel 2120. The resulting front board, back board and spine board pass from the circular knives to a second set of press rolls 2130. At a synchronized time, the board parts are fed to the combining area at the top of the sheet transport roll 2140.

In section 3000, the board parts are combined with the print sheet. At the top of the transfer roll the board parts are fed into contact with the glued print sheet and combine between the transfer roll and a press roll above the transfer roll 3010. The combined board parts and print sheet are fed through press rolls to a folding station where the bottom and top edges are first folded over and then the right and left edges are folded over according to instructions derived from the bar code on the print sheet 3020.

### Additional Examples

Example 1 is a method of producing a hard cover case for a book, the method comprising
providing a print sheet including an image thereon, aligning the print sheet by registering two adjacent edges of the sheet at a plurality of stations, trimming only two adjacent edges of the print sheet, affixing the trimmed print sheet to a plurality of board pieces, and folding the print sheet around the board pieces to produce the hard cover case.

Example 2 is Example 1 wherein the board pieces include a front board, a back board and a spine board made from a common original board and wherein none of the front board, back board and spine board include an edge in common with the original board.

Example 3 is Example 1 or 2 further comprising detecting the position of the print sheet by using an optical sensor to find the two adjacent edges.

Example 4 is any of the previous examples wherein multiple optical sensors are used to locate the two adjacent edges at different stages during the process.

Example 5 is any of the previous examples further comprising gluing a book block to the hard cover case to produce a finished book.

Example 6 is any of the previous examples comprising reading a bar code on the print sheet that encodes or points to instructions for cutting the board pieces.

Example 7 is any of the previous examples wherein a bar code includes instructions for placement of the print sheet in relation to a knife or knives for trimming the print sheet.

Example 8 is any of the previous examples comprising folding the edges and corners of the print sheet around the board pieces of a first hard cover case having a first size and on the same apparatus trimming the board pieces and/or trimming the print sheet for a second, different sized hard cover case.

Example 9 is any of the previous examples comprising transporting the print sheet by compressing the print sheet between a drive wheel and a passive ball and turning the drive wheel.

Example 10 is any of the previous examples wherein the apparatus does not stop or skip cycles when switching from one size case to a different size case.

Example 11 is a method of producing a hard cover case for a book, the method comprising
loading into a hopper an original board to be cut to size for a front, a back and a spine of the hard cover case, after loading into the hopper, trimming all four sides of each of the front, back and spine to provide freshly cut edges on each side of each of a front, back and spine, and adhering a print sheet to the front, back and spine to produce the hard book cover.

Example 12 is the method of example 11 comprising reducing a width of the original board by trimming a portion off of a first end of the original board and reducing the width again by cutting additional portions off of each of the first end and a second end of the board.

Example 13 is the method of example 11 or 12 wherein the original board is fed to a first cutter in a first direction and to a second cutter in a second direction, the second direction different from the first direction.

Example 14 is the method of example 13 wherein the first direction is at a right angle to the second direction.

Example 15 is the method of any of examples 11-14 wherein the first direction is at a right angle to a direction of movement of a print sheet and the second direction is parallel to the direction of movement of the print sheet.

Example 16 is the method of any of examples 11-15 wherein the second direction is the same direction as the movement of an associated print sheet.

Example 17 is a method of producing a hard cover case for a book on a casemaking machine, the method comprising providing an original board to be cut into separate back, front and spine boards, removing material from the original board to form the front board, the spine board and the back board, maintaining a spatial relationship between the front board and the back board and the spine board throughout the process, and adhering the front board, back board and spine to the print sheet without altering the spatial relationship between the boards.

Example 18 is Example 17 wherein the material removed from between the spine board and the front board is directed below and in a direction opposed to the direction of travel of the spine and front boards.

Example 19 is Example 17 or 18 wherein the front board, back board and spine board are cut to specifications derived from a bar code on a print sheet that is associated with the boards.

Example 20 is Example 17, 18 or 19 comprising producing a second hard cover case of different dimensions from the hard cover case wherein the cutting dimensions are adjusted automatically using a bar code on a second print sheet associated with the second hard cover case.

Example 21 is a method of maneuvering a print sheet for a book on a casemaking machine, the method comprising placing the print sheet on a flat surface, the surface including at least two openings therein, at least two vertically oriented wheels aligned with the two openings, gripping the print sheet between each of the wheels and a corresponding ball that is forced against each wheel with the print sheet held therebetween, rotating the wheels in unison to move or rotate the print sheet, each of the balls passively rotating while providing pressure to engage the print sheet with the wheels, and reducing a force of the balls against the wheels to release the print sheet in a new position.

Example 22 is the method of example 21 wherein the balls are housed in cylindrical tubes.

Example 23 is Example 21 or 22 wherein the force of the balls against the wheels is provided by pressurized gas.

Example 24 is any of Example 21-23 wherein the balls are retracted by applying vacuum to the cylinder.

Example 25 is an apparatus for making cases for books, the apparatus comprising a print sheet feeder, a board feeder, a print sheet edge cutter, a print sheet corner cutter, a board cutter, a gluing station, and a folding station.

Example 26 is example 25 wherein the print sheet feeder, the print sheet edge cutter, the print sheet corner cutter, the gluing station and the folding station are aligned along a single axis.

Example 27 is example 25 or 26 wherein the board feeder is constructed and arranged to feed boards in a direction perpendicular to the single axis.

Example 28 is any of examples 25-27 comprising a first board cutter for slitting a board in a first direction and a second board cutter for slitting the board in a direction perpendicular to the first direction.

Example 29 is any of examples 25-28 wherein the board cutter comprises upper and lower carriage portions and a knife constructed and arranged to cut a hinge portion of a case, the upper carriage portion supporting an upper portion of the knife and the lower carriage portion supporting a lower portion of the knife.

Example 30 is any of examples 25-29 wherein the lower carriage portion is connected to the upper carriage portion via a support that is longitudinally aligned with the knife in the direction of transport.

Example 31 is any of examples 25-30 wherein the support passes through the space produced by removal of a hinge area.

Example 32 is any of examples 25-31 constructed and arranged to provide automatic sequential production of cases of varying sizes.

Example 33 is any of examples 25-32 comprising a bar code reader constructed and arranged to read bar codes off of print sheets.

Example 34 is any of examples 25-33 including a microprocessor for receiving bar code information and controlling one or more of the print sheet feeder, the board feeder, the print sheet edge cutter, the print sheet corner cutter, the board cutter, a second board cutter, the gluing station, and a folding station.

Example 35 is any of examples 25-34 wherein a lower carriage portion includes a concave semicircular surface positioned to direct waste material downward and away from the direction of advancement of a case.

Example 36 is a computer readable medium including instructions for carrying out the process of any of examples 1-24.

The foregoing detailed description has been presented for the purposes of illustration and description. It is not intended to be exhaustive or to limit the invention to the particular disclosed embodiments. Numerous variations and configurations will be apparent in light of this disclosure. Thus it is intended that the scope of the invention be defined not by this detailed description, but rather by the claims appended hereto.

1-16. (canceled)

17. A method of producing a hard cover case for a book on a casemaking machine, the method comprising:
providing an original board to be cut into separate back, front and spine boards;
removing material from the original board to form the front board, the spine board and the back board;
maintaining a spatial relationship between the front board and the back board and the spine board throughout the process; and
adhering the front board, back board and spine to the print sheet without altering the spatial relationship between the boards.

18. The method of claim 17 wherein the material removed from between the spine board and the front board is directed below and in a direction opposed to the direction of travel of the spine and front boards.

19. The method of claim 17 wherein the front board, back board and spine board are cut to specifications derived from a bar code on a print sheet that is associated with the boards.

20. The method of claim 17 comprising producing a second hard cover case of different dimensions from the hard cover case wherein the cutting dimensions are adjusted automatically using a bar code on a second print sheet associated with the second hard cover case.

21. A method of maneuvering a print sheet for a book on a casemaking machine, the method comprising:
placing the print sheet on a flat surface, the surface including at least two openings therein, at least two vertically oriented wheels aligned with the two openings;
gripping the print sheet between each of the wheels and a corresponding ball that is forced against each wheel with the print sheet held therebetween;
rotating the wheels in unison to move or rotate the print sheet, each of the balls passively rotating while providing pressure to engage the print sheet with the wheels; and
reducing a force of the balls against the wheels to release the print sheet in a new position.

22. The method of claim 21 wherein the balls are housed in cylindrical tubes.

23. The method of claim 22 wherein the force of the balls against the wheels is provided by pressurized gas.

24. The method of claim 22 wherein the balls are retracted by applying vacuum to the cylinder.

25. An apparatus for making cases for books, the apparatus comprising:
a print sheet feeder;
a board feeder;
a print sheet edge cutter;
a print sheet corner cutter;
a board cutter;
a gluing station; and
a folding station.

26. The apparatus of claim 25 wherein the print sheet feeder, the print sheet edge cutter, the print sheet corner cutter, the gluing station and the folding station are aligned along a single axis.

27. The apparatus of claim 26 wherein the board feeder is constructed and arranged to feed boards in a direction perpendicular to the single axis.

28. The apparatus of claim 25 comprising a first board cutter for slitting a board in a first direction and a second board cutter for slitting the board in a direction perpendicular to the first direction.

29. The apparatus of claim 25 wherein the board cutter comprises upper and lower carriage portions and a knife constructed and arranged to cut a hinge portion of a case, the upper carriage portion supporting an upper portion of the knife and the lower carriage portion supporting a lower portion of the knife.

30. The apparatus of claim 29 wherein the lower carriage portion is connected to the upper carriage portion via a support that is longitudinally aligned with the knife in the direction of transport.

31. The apparatus of claim 30 wherein the support passes through the space produced by removal of a hinge area.

32. The apparatus of claim 25 constructed and arranged to provide automatic sequential production of cases of varying sizes.

33. The apparatus of claim 25 comprising a bar code reader constructed and arranged to read bar codes off of print sheets.

34. The apparatus of claim 33 including a microprocessor for receiving bar code information and controlling one or more of the print sheet feeder, the board feeder, the print sheet edge cutter, the print sheet corner cutter, the board cutter, a second board cutter, the gluing station, and a folding station.

35. The apparatus of claim 29 wherein the lower carriage portion includes a concave semicircular surface positioned to direct waste material downward and away from the direction of advancement of a case.

36. A computer readable medium including instructions for carrying out the process of claim 17.
